(19) United States
(12) Patent Application Publication
(10) Pub. No.: US 2006/0172847 A1
(43) Pub. Date: Aug. 3, 2006

(54) Torque-vectoring defferential

(76) Inventor: Mircea Gradu, Massillon, OH (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/045,244

(22) Filed: Jan. 28, 2005

(51) Int. Cl. F16H 48/06

(52) U.S. Cl. 475/230

(57) ABSTRACT

A differential for selectively vectoring torque to left and right axle shafts that rotate about an axis includes a cage that rotates about the axis as a consequence of torque applied to it. The cage contains gearing that transfers the torque to the axle shafts while accommodating for variances in angular velocity between the axle shafts. In addition, the differential has left and right torque diverters for the left and right axle shafts, with each torque diverter including a planetary set connected between the cage and its axle shaft and a brake which imparts a reactive torque to its planetary set so that the planetary set diverts torque from the cage through the planetary set to its axle shaft. The brakes, which are preferably magnetic particle brakes, control the torque delivered to the axle shafts, so the differential has the capacity to vector the torque applied to its cage.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

This invention relates in general to differentials for automotive vehicles and, more particularly, to a differential that has the capacity to vector the torque transferred through it and to a process for vectoring torque in a differential.

When a wheeled automotive vehicle negotiates a turn, the wheels at the outside of the turn rotate faster than the wheels at the inside of the turn. A differential between the drive wheels on each side of the vehicle compensates for the variance in speed between the two drive wheels, but a conventional differential divides the torque generally evenly between those drive wheels. However, for optimum control of the vehicle the drive wheel on the outside of the turn should deliver more torque than the corresponding drive wheel on the inside of the turn. In effect, the increased torque applied to the drive wheel on the outside of the turn helps propel and steer the vehicle around the turn, and this is particularly beneficial in turns negotiated at high speeds.

Moreover, traction may vary between the drive wheels at opposite ends of the differential. If the traction under one of the drive wheels is poor enough, such as on ice, the differential distributes the torque such that the wheel simply spins, while the other wheel with better traction remains at rest. To be sure, limited-slip differentials exist, but that type of differential tends to bring both drive wheels to the same velocity. Where traction is good, this characteristic of limited-slip differentials detracts from the handling of a vehicle negotiating turns at high speeds.

### BRIEF DESCRIPTION OF THE SEVERAL VIEWS OF THE DRAWINGS

FIG. 1 is a sectional view of a differential constructed in accordance with and embodying the present invention;

FIG. 2 is a kinematic diagram of the differential;

FIG. 3 is a kinematic diagram of the differential showing the flow path of torque with its torque vectoring diverters inactivated; and;

FIG. 4 is a kinematic diagram of the differential showing the flow of torque with its left torque vectoring diverter activated.

### DETAILED DESCRIPTION OF THE INVENTION

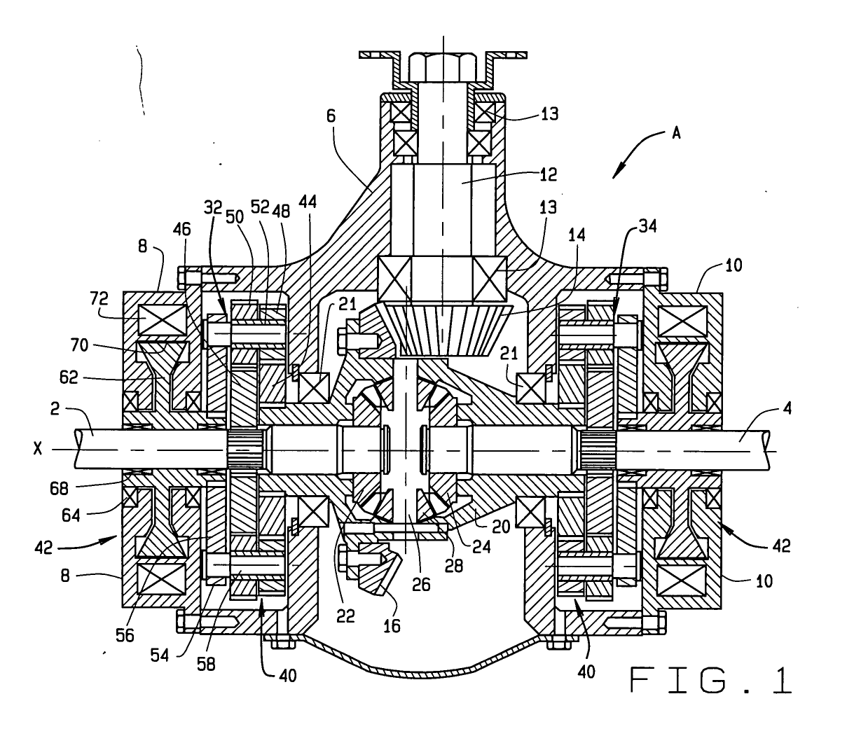

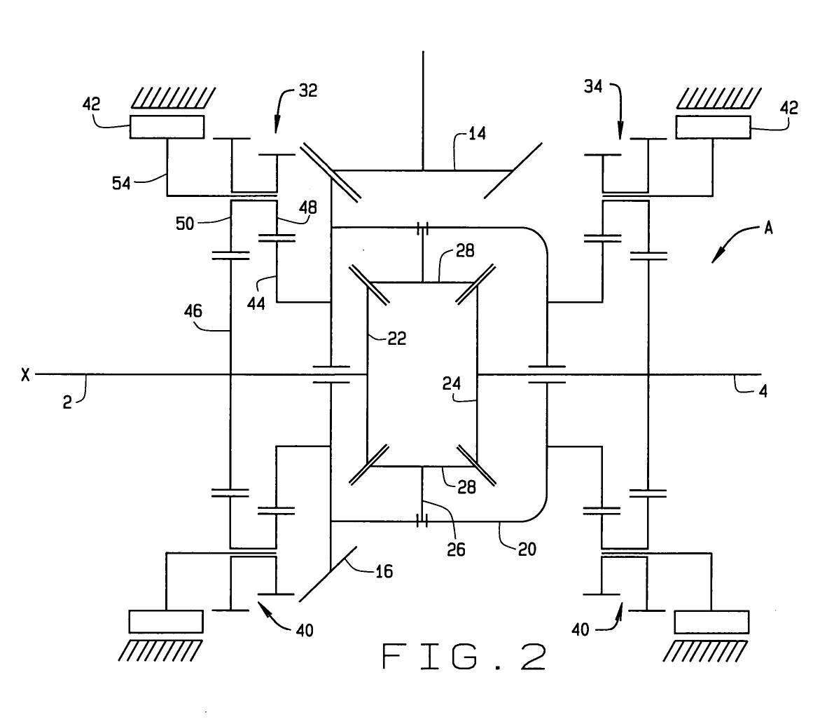

Referring now to the drawings, a differential A (FIG. 1) for an automotive vehicle distributes torque produced by the engine of the vehicle to two axle shafts 2 and 4 which rotate about a major axis X and are coupled to road wheels located, respectively, at the left and right sides of the vehicle. The differential A has the capacity to selectively vector the torque delivered to the two shafts 2 and 4, so that one of the shafts 2 or 4 may transfer greater torque than the other. This enhances control of the vehicle.

The differential A includes a housing 6 which contains the working components of the device and includes a left and right end closures 8 and 10. The left axle shaft 2 projects out of the left closure 8, whereas the right axle shaft 4 projects out of the right closure 10.

The differential A can function as a conventional differential and often does. To this end, it has (FIG. 1) a pinion shaft 12 that rotates in the housing 6 on bearings 13. The pinion shaft 12 carries a beveled drive pinion 14 at its inner end. The opposite or outer end of the pinion shaft 12 is coupled with the engine of the vehicle through the transmission of the vehicle. The pinion 14 meshes with a beveled ring gear 16 which is bolted firmly to a differential carrier or cage 20 that rotates about the axis X on bearings 21 located between the cage 20 and to the housing 10. The cage 20 contains gearing in the form of left and right beveled side gears 22 and 24 which are capable of rotating in the cage 20 and also with the cage 20 about the axis X. The left gear 22 is coupled to the left axle shaft 2, while the right gear 24 is coupled to the right axle shaft 4 so that the gears 22 and 24 and their axle shafts 2 and 4 rotate together at the same angular velocity or velocities. In addition to the two side gears 22 and 24, the cage 20 carries a cross pin 26, the axis of which is perpendicular to the axis X. The cross pin 26 is fitted with a pair of intervening beveled pinions 28 which mesh with the left and right side gears 22 and 24 and are also part of the gearing.

Thus, when the engine applies torque to and rotates the pinion shaft 12, the pinion 14 on it rotates the ring gear 16 and the cage 20 to which it is fastened. The cage 20 in turn causes the cross pin 26 to revolve about the axis X, and the revolving cross pin 26 causes the beveled pinions 28 that are on it to orbit about the axis X. The orbiting beveled pinions 28, being engaged with the left and right side gears 22 and 24, rotate those gears which in turn rotate the axle shafts 2 and 4. Should one of the axle shafts 2 or 4 rotate faster than the other, as when negotiating a turn, the beveled pinions 28 will rotate on the cross shaft 26, but will still transfer torque to the left and right side gears 22 and 24 and to the axle shafts 2 and 4 to which the gears 22 and 24 are connected, with the torque distributed evenly between the shafts 2 and 4.

But the differential A also has the capacity to vector torque between the two axle shafts 2 and 4, that is to say, to selectively distribute the torque that is applied at the pinion shaft 12 between the two axle shafts 2 and 4. To this end, the differential A is equipped with (FIGS. 1 & 2) a left torque diverter 32 and a right torque diverter 34, which are located within the housing 4 at the left enclosure 8 and the right enclosure 10, respectively. The left torque diverter 32, when energized, is capable of diverting additional torque from the ring gear 16 and cage 20 to the left axle shaft 2. The right torque diverter 34, when energized, is capable of diverting additional torque from the ring gear 16 and cage 20 to the right axle shaft 4. Should the left torque diverter 32 be energized, more torque will transfer through the left axle shaft 2 than the right axle shaft 4. Of course, the opposite occurs when the right torque diverter 34 is energized.

Each torque diverter 32 and 34 basically includes a planetary set 40 and a brake 42. The planetary set 40 preferably possesses a double planet configuration, whereas the brake 42 is preferably a magnetic particle brake, although other types of brakes are suitable.

Considering the planetary set 40 for the left diverter 32 in more detail, it includes an inner sun gear 44 that is fitted to the cage 20 with mating splines where the left axle shaft 2 emerges from the cage 20, so that the inner sun gear 44 rotates with the cage 20 at the angular velocity of the cage 20. In addition, the planetary set 40 has an outer sun gear 46 that is fitted to the left axle shaft 2 with more mating splines adjacent to both the end of the cage 20 and the inner sun gear 44 at that end. Thus, the outer sun gear 46 rotates with the left axle shaft 2 at the angular velocity of the left shaft 2. The two sun gears 44 and 46 mesh with planet gears 48 and 50, respectively, which are arranged in pairs around the sun gears 44 and 46, with the planet gears 48 and 50 of each pair being fitted to a common sleeve 52 that extends through the gears 48 and 50 such that the gears 48 and 50 are united in the sense that they cannot rotate independently of each other. Thus, the planet gears 48 and 50 of each pair rotate together at the same angular velocity. Completing the planetary set 40 is a carrier 54 including a flange 56 and pins 58 which project from the flange 56 into sleeves 52 that unite the planet gears 48 and 50. The pins 58 establish axes about which the pairs of planet gears 48 and 50 rotate.

The left magnetic particle brake 42 includes a rotor 62 that rotates in the left end closure 8 on bearings 64, with the axis of rotation being the axis X. The rotor 62 has a sleeve 66 which encircles the left axle shaft 2 immediately beyond the outer sun gear 46 for the left planetary set 40, and it supports the axle shaft 2 on two needle bearings 68 located between it and the shaft 2. The sleeve 66 projects inwardly toward the two sun gears 44 and 46 and into the flange 56 of the carrier 54 to which it is coupled by mating splines. Thus, the rotor 62 of the brake 42 and the carrier 54 of the planetary set 40 rotate at the same angular velocity. The periphery of the rotor 62 lies close to an interior cylindrical surface 70 in the enclosure 8, yet is spaced from the surface 70 so that a gap exists between the rotor 62 and surface 70. This gap contains magnetic particles. Slightly beyond the surface 70 the enclosure 8 has an electrical coil 72 embedded in it such that the coil 72 encircles the surface 70 and the rotor 64. The coil 72 also forms part of the brake 42.

When the coil 72 of the brake 42 for the left diverter 32 is energized, it exerts a reactive torque on the rotor 62 for that brake 42 and that torque resists rotation of the rotor 62. The carrier 54 of the planetary set 40 for the left diverter 32, being coupled at its flange 56 to the rotor 62, likewise experiences a resistance to rotation, and as a consequence, the planet gears 48 and 50 do not orbit freely about their respective sun gears 44 and 46. This causes them to divert more torque to the left axle shaft 2.

The right torque diverter 34 has essentially the same construction as the left torque diverter 32, only it is located at the other end of the cage 20. Its planetary set 40 and brake 42 do not differ from their counterparts in the left torque diverter 32.

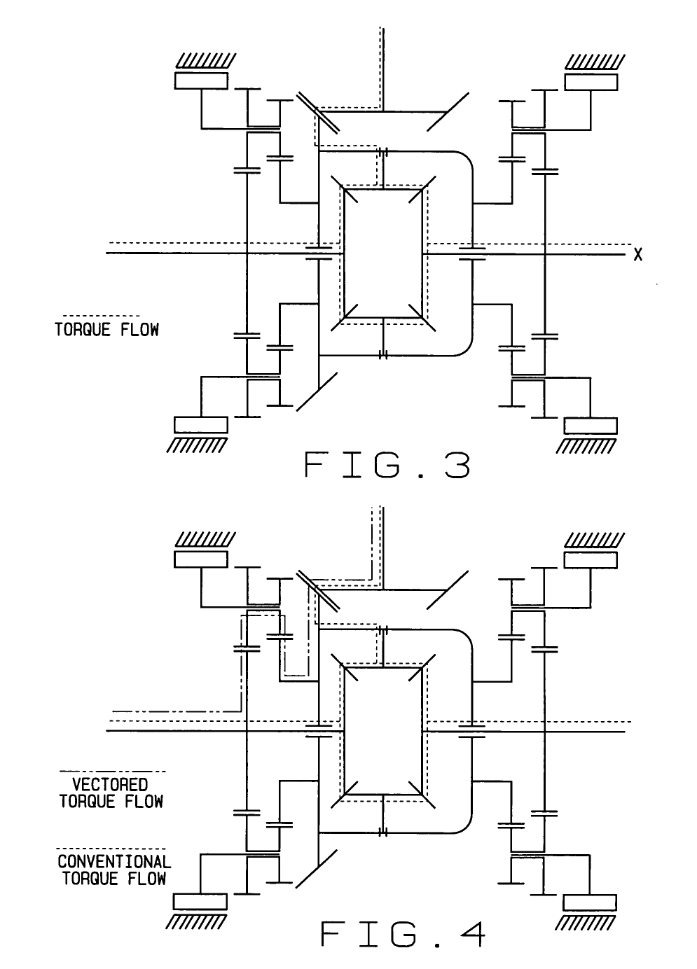

Normally, the differential A operates with both of its magnetic particle brakes 42 de-energized—that is to say—released, and this holds particularly true when the vehicle travels straight with good traction at both drive wheels. Under these circumstances the torque supplied at the pinion shaft 12 is divided equally between the left and right axle shafts 2 and 4 and the road wheels that they drive. This does not differ from a conventional differential. Indeed, the differential A in that condition operates essentially as a conventional differential, with all of the torque and power passing (FIG. 3) from the ring gear 16 to the differential cage 20 and thence to the cross pin 26. When the vehicle travels straight, the beveled pinions 28 do not rotate on the cross pin 26 as the pin 26 revolves about the axis X. The beveled pinions 28, without rotating themselves, simply turn the left and right beveled side gears 22 and 24 at the velocity of the cage 20 and cross pin 26, and the beveled side gears 22 and 24 rotate the axle shafts 2 and 4, respectively, at the same angular velocity. With the brakes 40 fully released the left and right torque diverters 32 and 34 transfer no torque of any consequence and otherwise do not affect the operation of the differential A. The two sun gears 44 and 46 of each planetary set 40 rotate at the same angular velocity with the cage 20 and left and right axle shafts 2 and 4, respectively. The planet gears 48 and 50 of each planetary set 40 orbit about the axis X at the angular velocity imparted to their sun gears 44 and 46, but do not rotate on their pins 58. As a consequence of the pins 58 being carried around by the orbiting planet gears 48 and 50, the two carriers 54 and the rotors 62 of the two brakes 42 revolve about the axis X, also at the angular velocity imparted to the cage 20 and axle shafts 2 and 4. The torque applied to the cage 20 at the ring gear 16 divides evenly between the left and right axle shafts 2 and 4.

Should the vehicle enter a right turn, the left drive wheel and its axle shaft 2 will rotate faster than the right drive wheel and its axle shaft 4. As a consequence, the outer sun gear 46, which is on the axle shaft 2, will overspeed with respect to the inner sun gear 44 which is on the cage 20. The speed differential causes the pairs of planet gears 48 and 50 to rotate about their respective pins 58 and in so doing orbit with respect to the two sun gears 44 and 46. They drive the pins 58 around the axis X at a velocity different from the velocities of either of the sun gears 42 and 44, and the carrier 54 revolves about the axis X at the velocity of the orbiting pins 58. Being connected to the carrier 54, the rotor 62 of the brake 42 revolves at the velocity of the carrier 54. Notwithstanding the difference in velocities between the two axle shafts 2 and 4, the torque remains equally divided between the shafts 2 and 4.

Some right turns can be negotiated better when more torque is applied to the left axle shaft 2 than the right axle shaft 4. To distribute the torque accordingly, the brake 42 of the left torque diverter 32 is energized by directing an electrical current through its coil 72. The energized coil 72 resists rotation of the rotor 62 which in turn resists rotation of the carrier 54 for the planetary set 40 in the left diverter 32. The reactive torque applied by the carrier 54 at its pins 58 transfers to the orbiting pairs of planet gears 48 and 50 and they divert torque from the cage 20 through the planetary set 40 of the left diverter 32 to the left axle shaft 2 (FIG. 4). This diverted torque combines with the torque directed in the conventional manner through the cross pin 26, pinions 28 and left side gear 22, so that the left axle shaft 2 delivers more torque than the right axle shaft 4. The reactive torque produced by the brake 42 varies almost linearly with the current directed through the coil 72, so the brake 42 is easily controlled and with it the distribution of torque between the two axle shafts 2 and 4.

Should it become desirable to increase the torque delivered to the right axle shaft 4, as is a left turn, the coil 72 of the brake 42 for the right torque diverter 34 is energized while the brake 42 of the left diverter 32 remains released. The brake 42 of the right diverter 34 imparts reactive torque to the planetary set 40 of the right diverter 34 in a similar manner with similar results.

The extent to which either brake 42 is applied depends on a number of conditions, all of which may be monitored by sensors on the vehicle and processed through a processor to control the current which operates the magnetic particle brakes 42. Among the conditions monitored are the speed of the vehicle, rate of yaw, the lateral acceleration of the vehicle, the steering angle, the wheel slip, engine and transmission operating parameters, and the temperature of the brakes 42, to name some.

Should the vehicle encounter road conditions which leave one drive wheel with considerably greater traction than the other drive wheel, both torque diverters 32 and 34 are energized to direct torque to both axle shafts 2 and 4 and the drive wheels at their ends. This prevents the wheel with the poor traction from simply spinning while little torque is delivered to the wheel with good traction, as will occur with a conventional differential.

The ring gear 16 of the differential A need not be beveled and driven by the beveled drive pinion 14, but instead may be driven by a pinion having its axis parallel to the axis X as in differentials commonly used in front wheel drive vehicles. Moreover, the brakes 42 for developing reactive torques in their corresponding planetary sets 40 may take other forms, such as brakes that rely on friction, fluids, or electrical fields to resist rotation. The axle shafts 2 and 4 need not extend all the way to the wheels, but may terminate at flanges or CV joints located immediately beyond the left and right end closures 8 and 10. Other types of planetary sets may be used in lieu of the sets 40.

1. A differential for distributing torque to left and right axle shafts of an automotive vehicle; said differential comprising:
a cage which rotates about a major axis under torque that is applied;
gearing within the cage for distributing at least some of the torque that is applied to the cage between the axle shafts while accommodating variances in velocity between the axle shafts;
a first planetary set located between the cage and the left axle shaft;
a first brake coupled with of the first planetary set such that the first brake, when applied, imparts a reactive torque to the first planetary set, causing the first planetary set to transfer torque between the cage and the left axle shaft;
a second planetary set located between the cage and the right axle shaft; and
a second brake coupled with the second planetary set such that the second brake, when applied, imparts a reactive torque to the second planetary set, causing the second planetary set to transfer torque between the cage and the right axle shaft.

2. A differential according to claim 1 wherein each of the planetary sets includes a sun gear on the cage and another sun gear in the axle shaft to which the planetary set transfers torque.

3. A differential according to claim 2 wherein each planetary set includes planet gears engaged with the sun gears.

4. A differential according to claim 3 wherein the planet gears for each planetary set are arranged in pairs, with each pair including a planet gear engaged with the sun gear on the cage and a planet gear engaged with the sun gear on the axle shaft.

5. A differential according to claim 4 wherein the planet gears of each pair are united so that they will rotate in unison and at the same angular velocity.

6. A differential according to claim 5 wherein the brake for each planetary set applies the reactive torque at the planet gears for the set.

7. A differential according to claim 5 wherein each planetary set further includes a carrier having pins about which the planet gears for the set rotate, and the brake for the planetary set is connected to the carrier, so as to resist rotation of the carrier.

8. A differential according to claim 7 wherein the brake for each planetary set is a magnetic particle brake.

9. A differential according to claim 1 wherein the brake for each planetary set is a magnetic particle brake.

10. A differential for distributing torque to left and right axle shafts of an automotive vehicle, said differential comprising:
a cage which rotates under torque applied to it;
gearing within the cage for distributing at least some of the torque that is applied to the cage to the axle shafts while accommodating variances in velocity between the axle shafts;
left and right first sun gears on the cage;
a left second sun gear on left axle shaft and a right second sun gear on the right axle shaft;
left planetary gears engaged with the left sun gears and right planet gears engaged with the right planet gears;
a left carrier providing axes about which the left planet gears rotate and a right carrier providing axes about which the right planet gears rotate; and
a left brake connected to the left carrier to resist rotation of the left carrier and a right brake connected to the right carrier to resist rotation of the right carrier.

11. A differential according to claim 10 wherein the left planet gears are arranged in pairs, with each pair including a first planet gear engaged with the left first sun gear and a second planet gear engaged with the left second sun gear; and wherein the right planet gears are arranged in pairs, with each pair including a first planet gear engaged with the right first sun gear and a second planet gear engaged with the right second sun gear.

12. A differential according to claim 11 wherein the first and second planet gears of each pair are united so that they will rotate in unison at the same angular velocity.

13. A differential according to claim 12 wherein the left carrier has pins that provide axes about which the pairs of left planet gears rotate; and wherein the right carrier has pins that provide axes about which the pairs of right planet gears rotate.

14. A differential according to claim 13 wherein the brakes are magnetic particle brakes.

15. A differential according to claim 10 wherein the brakes are magnetic particle brakes.

16. A process for vectoring torque in a differential that delivers torque to left and right axle shafts through a cage that contains gearing for transferring torque from the cage to the axle shafts while accommodating variances in velocity between the axle shafts, said process comprising:
diverting torque to the left axle shaft through a left planetary set located between the cage and the left axle shaft when appropriate and at the other times diverting torque to the right axle shaft through a right planetary set when appropriate.

17. The process according to claim 16 wherein each planetary set has a carrier and torque is diverted through the planetary set by resisting rotation of the carrier.

18. A process according to claim 17 wherein the carrier for each planetary set is connected to a magnetic particle brake to resist rotation of the carrier.
